(19) United States
(12) Patent Application Publication
(10) Pub. No.: US 2008/0201176 A1
(43) Pub. Date: Aug. 21, 2008

(54) PRACTICE MANAGEMENT SYSTEM (PMS) INTEGRATION METHOD

(75) Inventors: Mark Keck, New York, NY (US); Sarah Harrison, New York, NY (US); Ahana Kalappa, New York, NY (US); Sunil Sachdev, New Rochelle, NY (US); Margaret A. Miller, Land O Lakes, FL (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/675,456

(22) Filed: Feb. 15, 2007

(51) Int. Cl. G06Q 40/00

(52) U.S. Cl. 705/4

(57) ABSTRACT

A method and computer program product for integrating verification of eligibility information of a card member enrolled in a health plan with a payment account required to pay for the services used according to the health plan is described. The present invention integrates card member information to a method which provides payment capabilities for services used by the card member. The invention encodes basic patient eligibility information onto a card magnetic stripe. This helps in overcoming any manual data entry errors that can resulted from a paper-based or paperless electronic process. The invention provides the ability to complete a transaction involving a medical service provider, a patient and a payer in a single swipe of card.

### BACKGROUND OF THE INVENTION

1. Field of the Invention

The present invention generally relates to integrating eligibility information and financial information, and more particularly to using the eligibility information to authorize payment to a service provider for services rendered.

2. Related Art

In the present day healthcare scenario, how consumers pay for healthcare expenditures is changing. Presently, less than 20% of consumer healthcare payments is through use of “plastic,” which includes debit cards, charge cards, and credit cards. This percentage is expected to grow by over 10% in five years to approximately 30% by 2010.

Another fundamental change that is expected to occur in the healthcare industry is the increase in use of more focused healthcare plans like consumer-directed healthcare plans (“CDHPs”), which offer tax advantages to employers who offer such plans and, for some CDHPs, to employees as well. The shift towards CDHPs, while providing tax and other benefits to employers and/or employees, also entails significant administrative costs borne by the employers. These costs include, for example, the costs associated with maintaining individual accounts for each participating employee. Additionally, providers of healthcare goods/services often encounter significant delays in payment from various healthcare plans, due to the amount of time necessary to determine the respective payment responsibilities of the consumers and the insurers. Providers also encounter additional delays in collecting consumers' payments due after they have received services from a service provider.

As these healthcare plans become more and more prevalent, the amount of patient responsibility for services and treatments is increasing. Further, the risk of collection is shifting from payers (e.g., health plans) to the service providers. To ensure proper payment for their services, providers must, amongst other functions, perform a check to see if the patients have insurance, determine what procedures are covered under a patient's health plan and determine patient payments and collect charges.

Currently available solutions are prone to errors for many reasons. One of them is incorrect entry of data by low-skilled staff. Additionally, due to the extensive paperwork and compliance with government rules, current workflow for checking eligibility is very cumbersome and resource-intensive for office administrators. Though the problem of verifying eligibility has been around since the inception of managed care, currently available systems attempt to solve it for the manual entry of data by using bar-code readers. However, bar-code readers require additional technology, apart from a magnetic card payment method, in a provider's office and it does not integrate financial information about a patient or a transaction with a patient's eligibility verification information.

Given the foregoing, what is needed is a system, method and computer program product for expediting and error-proofing the eligibility verification and payment process. Further it is needed to automate above mentioned process to as high a degree as possible. In addition, due to increasing instances of organizations and bodies opting for CDHPs, there is a need to handle larger amounts of payments and eligibility information in an efficient manner.

### SUMMARY OF THE INVENTION

The present invention meets the above-mentioned needs by providing a method and computer program product for highly efficient and fast patient eligibility verification and payment processing. This invention differs from the existing systems in use because it builds on a provider's pre-existing administrative processes for handling and automating claims processing and allows for the integration of financial transaction and eligibility verification all in one swipe of a magnetic card, thereby eliminating the need for cumbersome and error-prone manual entry of patient data. Additionally, by using a magnetic card swipe method, a much larger network of care providers can be integrated into and according to the various embodiments of the present invention. Such a method can be practiced by a provider for providing a solution for claims and/or eligibility checks submitted by a provider for services availed by an employee as an electronic or paper transaction. Various embodiments of the present invention will be described in this specification. Further, such a method may include one or more of a claims processing method, a clearing mechanism for claims processing and methods for handling electronic claims processing.

Various embodiments of the present invention provide a method and computer program product for verifying patient eligibility data and payment information in a single step. The various embodiments may also include performing one or more of the aforementioned functions independently and in any order, as per the need.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is a block diagram showing various elements involved in an exemplary environment, in which an embodiment of the present invention may be implemented;

FIG. 2 is a flowchart illustrating the process of validation of a patient's information in an exemplary environment, in which another embodiment of the present invention may be implemented;

FIG. 3 is a flowchart illustrating a process of providing service to a patient post eligibility verification;

FIG. 4 illustrates three magnetic tracks present at the back of a card used by a patient in an exemplary environment;

FIG. 5 is a flowchart illustrating the authorization and payment process by the card company to a service provider;

FIG. 6 is a block diagram of an exemplary computer system for implementing the present invention.

### DETAILED DESCRIPTION

### I. Overview

The detailed description of exemplary embodiments of the invention herein makes reference to the accompanying drawings and figures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system. The present invention is directed to a system, method and computer program product for verifying the eligibility of a patient (or a card member) for services requested and authorizing payment for said services post verification. The steps of eligibility verification and authorization of payment can be done together or separately. According to one embodiment of the present invention, both steps of eligibility verification and authorization of payment can be integrated and performed in a single swipe of a card at a wedge card reader terminal. Although embodiments of the invention are being described in terms of a magnetic card reader, it should be noted that the invention can also be implemented using any other technology, for example, a web portal, as can be contemplated by one skilled in the art. The use of a magnetic card reader is therefore, given for example only and not for any limitation. The invention also leads to a reduction in data entry errors arising due to manual entry of card member data and other human factor errors. Apt implementations of the various embodiments of the invention also lead to a reduction in paper work involved in a practice management system, especially but not limited to eligibility verification and payment process.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The present invention is now described in more detail herein in terms of the above exemplary system, method and computer program product. This is for convenience only and is not intended to limit the application of the present invention. In fact, after reading the following description, it will be apparent to one skilled in the relevant art(s) how to implement the following invention in alternative embodiments.

### II. System

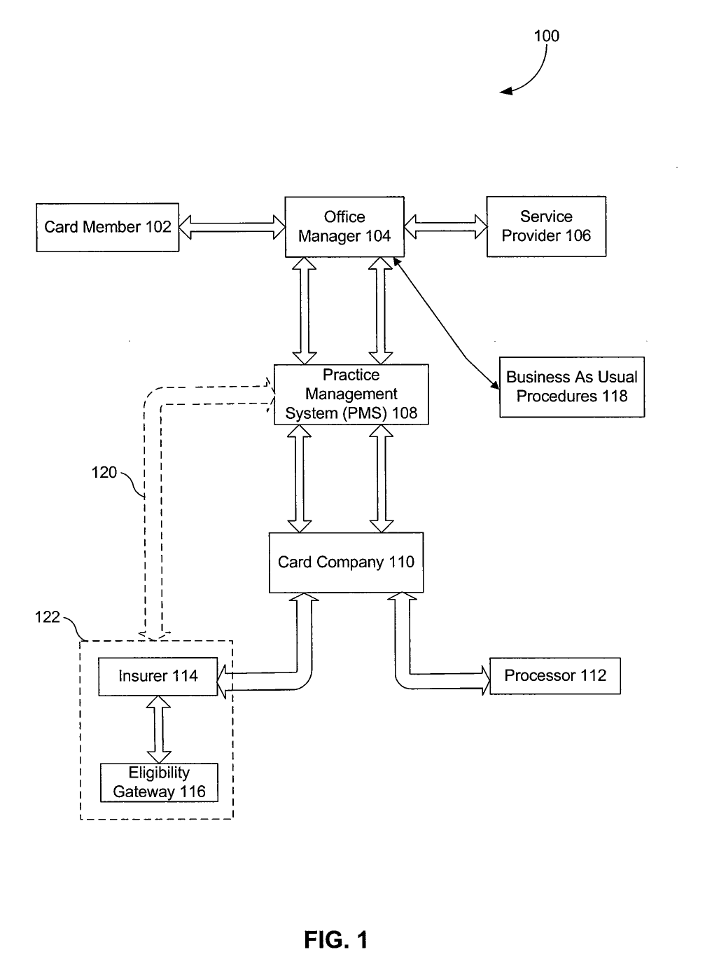

FIG. 1 is a block diagram of an exemplary integrated Practice Management System (PMS) (from now on, referred to as system 100) for eligibility verification and authorization of payment for services used by a card member 102.

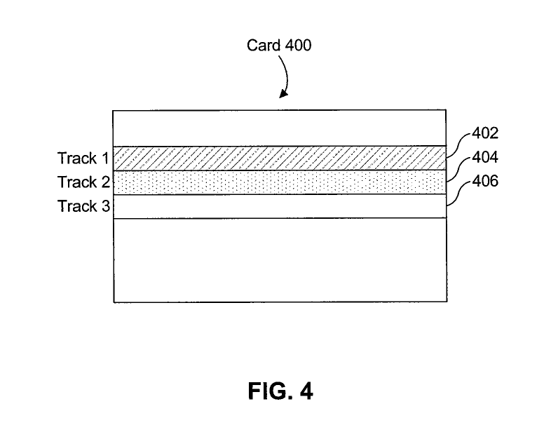

System 100 shows a card member 102 wishing to use the services of a service provider 106. According to one embodiment of the present invention, card member 102 may present a magnetic stripe card 400 (shown in detail in FIG. 4) to an office manager 104 present at any one of many offices that service provider 106 may have. Alternatively, card member 102 may present any other form of electronic data processing device, like a radio frequency identification tag (RFID tag), as can be contemplated by one skilled in the art. In an exemplary scenario, card member 102 can be a patient requesting and needing health care and the service provider 106 can be a physician providing health care. Once magnetic stripe card 400 is presented to office manager 104, he or she will swipe it at a magnetic card reading device, e.g., a wedge reader. Magnetic stripe card 400 contains, among other information, financial and eligibility information for a card member. This information can be stored, for example, in tracks or sectors or any other format conceivable to those skilled in the art, per various industry standards. Eligibility information stored in a region of magnetic stripe card is transmitted via the reading means to a practice management system 108.

Practice management system 108 can be located on a physician's computer or could be a web based portal. Further, practice management system 108 could be a backend system comprising various databases and rule engines, as will be apparent to one skilled in the art. The physical or virtual location of the practice management system 108 should not be interpreted as a limitation for the features described in various embodiments of this invention. Practice management system 108 can be integrated at different points in the system 100. Further, practice management system 108 could also be a distributed system on various host servers and computer systems, as is well known to one skilled in the art. Practice management system 108 can be used to encrypt card member 102's personal information. Similarly, practice management system 108 can also have various in-built security measures to prevent any malicious individual, system or computer code from misusing card member 102's data. Once information from the magnetic stripe card 400 is sent to the practice management system 108, practice management system 108 runs various rule checks on the data and depending on card member 102's healthcare plan information, forwards it to a card company 110. Some exemplary practice management systems are available from MiSys Healthcare Systems, United Kingdom, Emdeon Inc. of Elmwood Park, N.J., USA or. McKesson of San Francisco, Calif., USA.

Card company 110, like practice management system 108, could be a database, a rule engine, a distributed network, or any other customized computing environment well known to those skilled in the art. Card company 110 has an account entry corresponding to every card member like card member 102. In an exemplary scenario, on receiving data from practice management system 108, card company 110 contacts insurer 114 to collect further information, especially insurance eligibility related information for card member 102. Insurer 114 works in tandem with an eligibility gateway 116 that has the eligibility information for card member 102. Eligibility gateway 116 could also be a sub-component of insurer 114's system (as shown by dotted box 122) or be independent from insurer 114, depending upon specific needs. Further, eligibility gateway 116 could be any standard implementation of databases well known to one skilled in the art. Further details on such databases and computer systems are described below. After running a check on a particular card member 102, eligibility gateway 116 returns this information back to card company 110 via insurer 114. Card company 110 passes the eligibility information to the practice management system 108 which converts it in a presentable form for office manager 104 to read. Once the eligibility information for card member 102 has been reviewed by office manager 104, card member 102 can proceed to receive services from service provider 106.

In an alternative scenario, practice management system 108 can directly contact insurer 114 to obtain eligibility information about card member 102′ healthcare plan. In such a scenario, insurer 114 and practice management system 108 are directly in communication with each other and do not need to involve card company 110 in the process flow. Such a process flow is depicted by dotted arrow 120.

For purposes of billing card member 102 for the services availed through service provider 106, office manager 104 can probe practice management system 108 to obtain financial information from magnetic stripe card 400, which was earlier swiped at a wedge card reader when card member 102 had initiated the process described by system 100. Magnetic stripe card 400 includes financial information in regions different from the region that stores the eligibility information. Card member 102's financial information is held by practice management system 108 and is optionally not released till the eligibility information is verified. However, for successively identical repeat operations eligibility and financial information for a card member can be released simultaneously. Practice management system 108 then contacts card company 108 to procure authorization information from a processor 112. Processor 112 can be, for example and not for limitation, a database with control logic included in it. Processor 112 can also exclusively be a card processor. Once card company 110 receives authorization information from processor 112, it communicates this information to practice management system 108 which, after performing a rules check, passes the authorization to bill card member 102 to office manager 104. For example, a rules check could involve obtaining and verifying authorization information for a particular transaction corresponding to a card member 102.

In conjunction with a “business-as-usual” component 118, office manager 104 can at regular intervals of time generate invoices or bills showing actual charges incurred for the services used by card member 108.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing consumer files using an ISO/IEC 7816-4 file structure; implementing a domain whereby a dedicated file is selected that exposes one or more elementary files containing one or more data sets; using data sets stored in consumer files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial payment instrument or external to but affiliated with the financial payment instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial payment instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial payment instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain consumers, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the payment instrument user at the stand alone device, the appropriate option for the action to be taken. The present invention may contemplate a data storage arrangement wherein the header or trailer, or header or trailer history, of the data is stored on the payment instrument in relation to the appropriate data.

One skilled in the art will also appreciate that, for security reasons, any databases, systems, devices, servers or other devices of system 100 may consist of any combination thereof at a single location or at multiple locations, wherein each database or system includes any of various suitable security features, such as firewalls, access codes, encryption, decryption, compression, decompression, and/or the like.

System 100 may be described herein in terms of functional block components and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, system 100 may be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, system 100 may be embodied as a customization of an existing system, an add-on product, upgraded software, a stand-alone system, a distributed system, a method, a data processing system, a device for data processing, and/or a computer program product. Accordingly, system 100 may take the form of an entirely software embodiment, an entirely hardware embodiment, or an embodiment combining aspects of both software and hardware. Furthermore, system 100 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

### III. Process

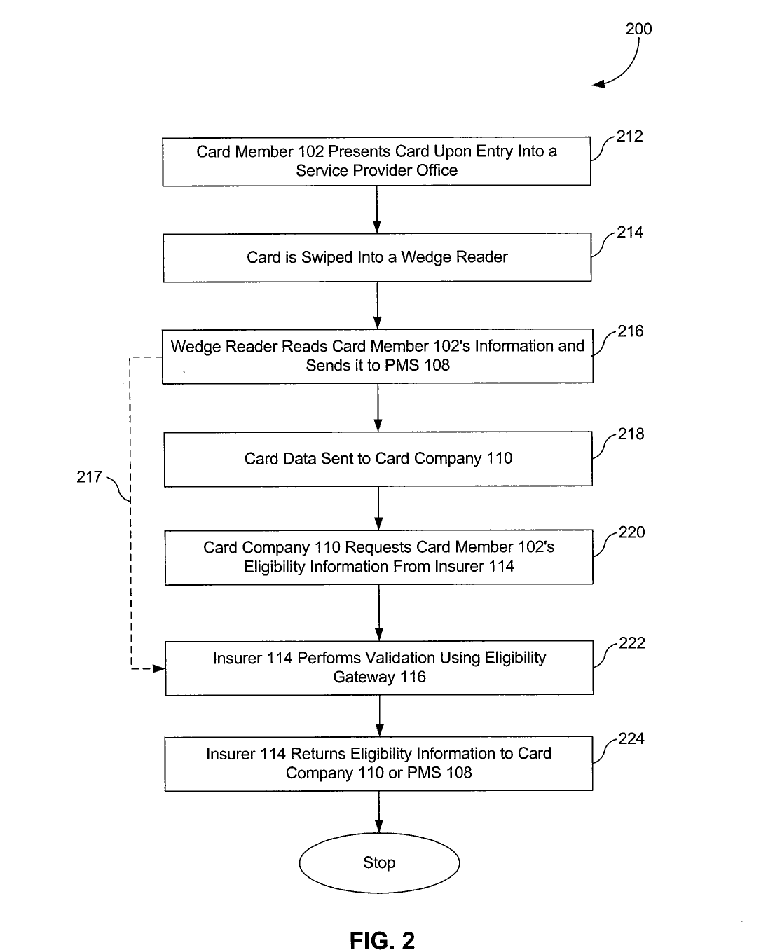

FIG. 2 is a flowchart illustrating a process 200 of validating a card member 102's information for various eligibility checks. In step 212 card member 102's medical and financial information is read by a card reading device, for example a wedge card reader. This is done, for example, by swiping the card on the wedge card reader, as shown in step 214. In step 216, the wedge card reader reads and transmits the information to practice management system 108.

In step 218, practice management system 108 transmits the card member 102's data to card company 110. This transmission may optionally be encrypted. The encryption technology could be any amongst those well known to those skilled in the art.

Alternatively, if practice management system 108 receives sufficient information from card member 102, practice management system 108 can directly communicate with insurer 114, as shown by dotted arrow 217.

In step 220, card company 110 requests card member 102's eligibility information from insurer 114.

In step 222, insurer 114 communicates card company 110's request as a query to eligibility gateway 116.

In step 224, eligibility gateway 116 retrieves queried eligibility information for card member 102 and passes it on to card company 110, or directly to practice management system 108, via insurer 114. With the completion of step 224, basic eligibility information of card member 102 is retrieved. However, the steps described for process 200 do not have to be necessarily carried out in the same order for any contemplated embodiment of the present invention to work as desired.

Process 300 begins at step 302, where card company 110 sends eligibility information retrieved in process 200 to practice management system 108. As mentioned, immediately above, practice management system 108 may also receive this eligibility information directly from insurer 114. In step 304, practice management system 108 formats the patient eligibility information so that it is readable by receiving office manager 104. Based on the eligibility information that office manager 104 receives, card member 102 is informed of services covered in his or her healthcare plan, as shown in step 308.

In step 312, service provider 106 documents services provided and forwards a consolidated report to office manager 104. Finally, in step 314, office manager 104 presents charges billed to card member 102.

FIG. 4 shows an exemplary magnetic stripe card 400 containing regions 402, 404 and 406. According to one embodiment of the invention, region 402 may be called track 1, region 404 may be called track 2 and region 406 may be called track 3 of the magnetic stripe card 400. According to yet another embodiment of the invention, regions 402 and 404 may contain financial information corresponding to a card member 102 and region 406 may contain eligibility and other information related to card member 102. Alternatively, magnetic stripe card 400 can have a larger or a smaller number of regions than those shown in FIG. 4. Also, the present invention is not limited in terms of its allocation of the type of information stored in regions 402-406. Further, as can be envisioned by those skilled in the art, the current invention can be implemented by other forms of data storage and processing devices, like RFIDs, chip cards and the like.

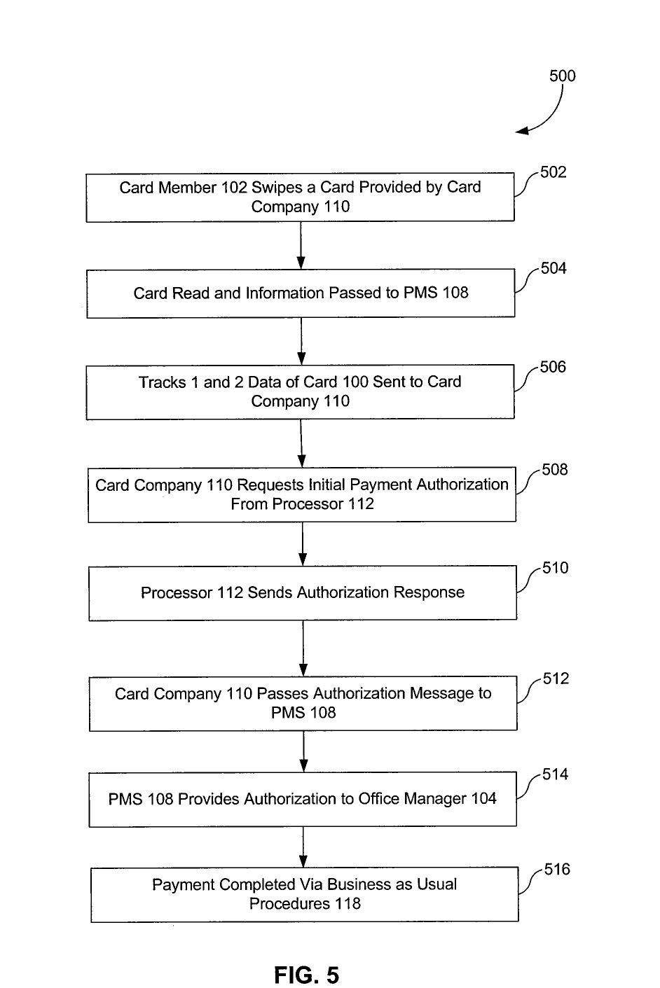

FIG. 5 shows a process 500 which outlines the steps required for authorization of payment for services used by card member 102. In step 502, after charges have been presented to card member 102 by office manager 104, a payment authorization transmittal is obtained from card company 110 (or in some cases, from insurer 114). Card member 102 may need to swipe magnetic stripe card 400 again at the wedge card reader in service provider 106's office or office manager 104 may use previous swipe information to authorize and automatically debit card member 102's account with card company 110.

In step 504, information is passed to practice management system 108, in case the card is swiped again. In step 506, practice management system 108 sends data, which it had previously held, from regions 402 and 404 (corresponding, for example, to tracks 1 and 2 of magnetic stripe card 400). Card company 110 requests initial payment authorization from processor 112 in step 508.

After performing checks related to a authorization request like matching card holder with a card number, processor 112 sends back an authorization response to card company 110 in step 510.

In step 512, card company 110 passes the authorization message to practice management system 108. Following this, in step 514, practice management system 108 forwards the authorization message to office manager 104.

Finally, in step 516, office manager 104 completes the payment process via a “business-as-usual” component 118.

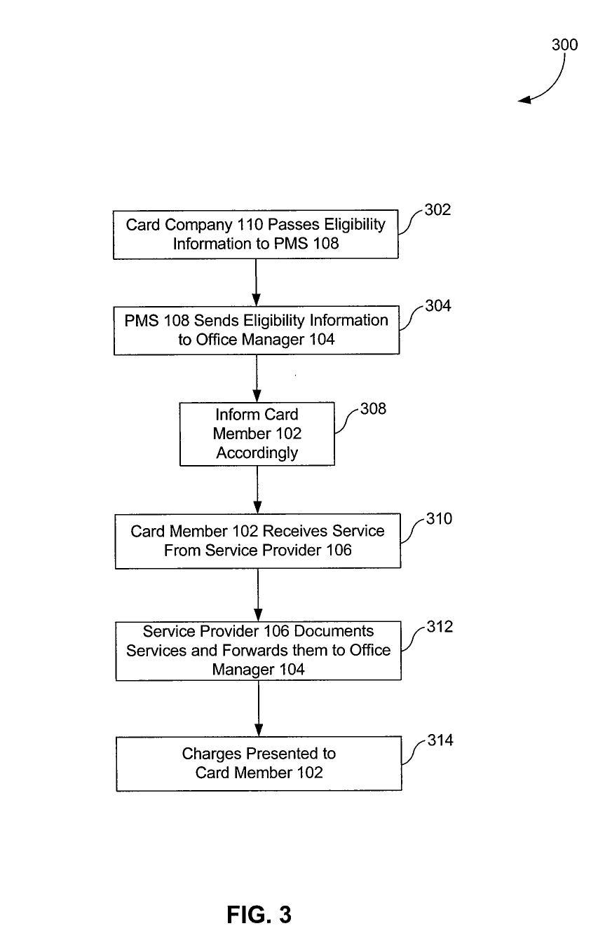

As mentioned before elsewhere in this description, the steps outlined in any of the FIGS. 2, 3 and 5 can be accomplished in any order. Even further, the processes 200, 300 and 500 can in fact be carried out in parallel and for multiple card members and service providers. Therefore, the invention embodies, amongst other things, an integration of the eligibility verification and payment authorization process leading to the exemplary integrated practice management system shown in FIG. 1.

### IV. Example Implementations

The present invention (i.e., system 100, process 200, process 300, process 500 or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

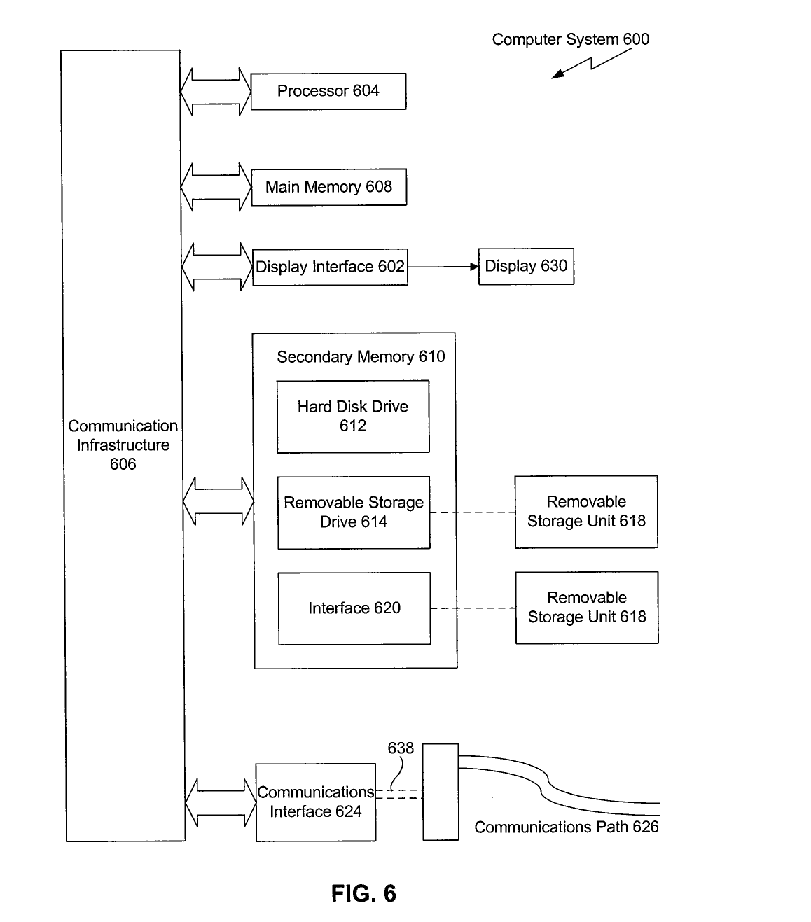

In fact, in accordance with an embodiment of the present invention, the present invention is directed towards one or more computer systems capable of carrying out the functionality described herein. An example of the computer systems includes a computer system 600, which is shown in FIG. 6.

Computer system 600 includes one or more processors, such as a processor 604. Processor 604 is connected to a communication infrastructure 606, for example, a communications bus, a cross over bar, a network, and the like. Various software embodiments are described in terms of this exemplary computer system 600. After reading this description, it will become apparent to a person skilled in the relevant art(s) how to implement the present invention using other computer systems and/or architectures.

Computer system 600 includes a display interface 602 that forwards graphics, text, and other data from communication infrastructure 606 (or from a frame buffer which is not shown in FIG. 6) for display on a display 630.

Computer system 600 also includes a main memory 608, such as random access memory (RAM), and may also include a secondary memory 610. Secondary memory 610 may include, for example, a hard disk drive 612 and/or a removable storage drive 614, representing a floppy disk drive, a magnetic tape drive, an optical disk drive, etc. Removable storage drive 614 reads from and/or writes to a removable storage unit 618 in a well known manner. Removable storage unit 618 represents a floppy disk, magnetic tape, optical disk, and the like. Removable storage unit 618 may be read by and written to by removable storage drive 614. As will be appreciated, removable storage unit 618 includes a computer usable storage medium having stored therein, computer software and/or data.

In accordance with various embodiments of the present invention, secondary memory 610 may include other similar devices for allowing computer programs or other instructions to be loaded into computer system 600. Such devices may include, for example, a removable storage unit such as removable storage unit 618, and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 618 to computer system 600.

Computer system 600 may also include a communication interface 624. Communication interface 624 allows software and data to be transferred between computer system 600 and external devices. Examples of communication interface 624 may include a modem, a network interface (such as an Ethernet card), a communications port, a Personal Computer Memory Card International Association (PCMCIA) slot and card, and the like. Software and data transferred via communication interface 624 are in the form of a plurality of signals, hereinafter referred to as signals 638, which may be electronic, electromagnetic, optical or other signals capable of being received by communication interface 624. Signals 638 are provided to communication interface 624 via a communication path (e.g., channel) 626. Communication path 626 carries signals 638 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 614, a hard disk installed in hard disk drive 612, signals 638, and the like. These computer program products provide software to computer system 600. The present invention is directed to such computer program products.

Computer programs (also referred to as computer control logic) are stored in main memory 608 and/or secondary memory 610. Computer programs may also be received via communication interface 624. Such computer programs, when executed, enable computer system 600 to perform the features of the present invention, as discussed herein. In particular, the computer programs, when executed, enable processor 604 to perform the features of the present invention. Accordingly, such computer programs represent controllers of computer system 600.

In accordance with an embodiment of the present invention, where the present invention is implemented using software, the software may be stored in a computer program product and loaded into computer system 600 using removable storage drive 614, hard disc drive 612 or communication interface 624. The control logic (software), when executed by processor 604, causes processor 604 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method for verifying eligibility information and authorizing payment for a card member comprising:
validating account information related to the card member;
determining the card member's eligibility for one or more services requested by the card member, based on the validation step results;
billing the card member for the one or more services availed;
communicating with a processor for authorization of payment to a service provider after the billing step; and
executing an automatic payment to the service provider based on the processor's response.

2. The method of claim 1, wherein the steps of validating, determining the card member's eligibility and billing are all performed in a single step.

3. The method of claim 2, wherein said single step is a card swipe on a wedge reader.

4. The method of claim 1, wherein the step of validating comprises:
(a) reading information stored in a card associated with the card member;
(b) sending the information to a card company;
(c) requesting card member eligibility information from an insurer;
(d) contacting an eligibility gateway for retrieving data to be used for determining the card member's eligibility for one or more services;
(e) transmitting the retrieved data to the card company and to an office of the service provider via a practice management system; and
(f) holding financial information related to the card member until the card member eligibility information is verified.

5. The method of claim 1, wherein the step of determining the card member's eligibility further comprises:
(a) encoding basic card member eligibility information on a region of a data storage device; and
(b) providing services to the card member based on whether or not the card member is eligible for said services.

6. The method of claim 5, wherein step (a) occurs on one or more of a plurality of tracks.

7. The method of claim 1, wherein the step of billing further comprises:
(a) reading card data; and
(b) sending read data to a card company.

8. The method of claim 1, further comprising:
displaying results of the validating and determining steps on a web-based a web-based portal.
